(19) United States
(12) Patent Application Publication
(10) Pub. No.: US 2026/0315964 A1
(43) Pub. Date: Oct. 15, 2026

(54) FILTER UNIT AND IMAGE FORMING APPARATUS

(71) Applicant: Yuusuke MASU, Miyagi (JP)

(72) Inventor: Yuusuke MASU, Miyagi (JP)

(73) Assignee: ETRIA CO., LTD., Yokohama-shi (JP)

(21) Appl. No.: 19/563,589

(22) Filed: Mar. 11, 2026

(30) Foreign Application Priority Data
Apr. 14, 2025 (JP) 2025-066196

(51) Int. Cl. B01D 29/05; G03G 21/20

(52) U.S. Cl. CPC B01D 29/05; G03G 21/206; B01D 2201/0415; B01D 2201/12; B01D 2201/28

(57) ABSTRACT

A filter unit includes: a filter having a plate shape elongated in a longitudinal direction; a pair of outer frames sandwiching the filter between the pair of outer frames, wherein the pair of outer frames has an opening covered by the filter sandwiched by the pair of outer frames; and the pair of outer frames includes: a pair of conversion portions each having a pleated face along a longitudinal direction of the pair of outer frames, the pair of conversion portions to deform, into a pleated shape, both ends of the filter in a transverse direction orthogonal to the longitudinal direction; and a pair of flat portions each having a flat face along the transverse direction, and the pair of outer frames is detachably engageable with each other to change the pleated shape of the filter by the pair of conversion portions.

### CROSS-REFERENCE TO RELATED APPLICATIONS

This patent application is based on and claims priority pursuant to 35 U.S.C. § 119(a) to Japanese Patent Application No. 2025-066196, filed on Apr. 14, 2025, in the Japan Patent Office, the entire disclosure of which is hereby incorporated by reference herein.

### BACKGROUND

### Technical Field

The present disclosure relates to a filter unit including a filter and an outer frame that holds the filter, and an image forming apparatus such as a copying machine, a printer, a facsimile, each of which includes the filter unit, or a multifunction peripheral thereof.

### Related Art

In an image forming apparatus such as a copying machine or a printer, a filter is provided in order to collect ozone, dust, and the like generated in the apparatus so that these matters are not discharged to the outside of the apparatus, or to collect foreign substances contained in air sucked into the apparatus from the outside of the apparatus.

In order to increase an area of a collection surface of the filter, the filter is used in a state where two outer frames holding the filter are meshed with each other to deform the filter into a pleated shape.

### SUMMARY

The present disclosure disclosed herein provides a filter unit including: a filter having a plate shape elongated in a longitudinal direction; a pair of outer frames sandwiching the filter between the pair of outer frames, wherein the pair of outer frames has an opening covered by the filter sandwiched by the pair of outer frames; and the pair of outer frames includes: a pair of conversion portions each having a pleated face along a longitudinal direction of the pair of outer frames, the pair of conversion portions to deform, into a pleated shape, both ends of the filter in a transverse direction orthogonal to the longitudinal direction; and a pair of flat portions each having a flat face along the transverse direction, and the pair of outer frames is detachably engageable with each other to change the pleated shape of the filter by the pair of conversion portions.

The present disclosure disclosed herein further provides a filter unit including: a filter having a plate shape elongated in a longitudinal direction; an outer frame having a slit through which the filter is movable in the longitudinal direction, wherein the outer frame has an opening covered by the filter in the slit; and the slit has: a conversion portion: disposed at one end of the outer frame in a transverse direction orthogonal to the longitudinal direction; and having a pleated face along a longitudinal direction of the outer frame; to deform the filter into a pleated shape; and a pair of flat portions at each end of the outer frame in the longitudinal direction, each having a flat face along the transverse direction, and the filter is movable in the longitudinal direction to change the pleated shape of the filter by the conversion portion.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIG. 1 is an overall configuration diagram illustrating an image forming apparatus;

FIG. 2 is a diagram illustrating an exhaust path in which a filter unit is installed;

FIG. 3 is a perspective view illustrating the filter unit;

FIG. 4 is a perspective view illustrating a state in which an outer frame of the filter unit is divided;

FIG. 5 is a perspective view illustrating a filter before the filter is held by the outer frame;

FIGS. 6A and 6B are side views illustrating a state in which the filter is deformed into a pleated shape in the filter unit;

FIG. 7 is a perspective view illustrating a state before a filter is held by an outer frame of the filter according to Modification 1;

FIGS. 8A and 8B are side views illustrating a state in which the filter of FIG. 7 is deformed into a pleated shape in a filter unit;

FIG. 9 is a perspective view illustrating a filter unit according to Modification 2;

FIGS. 10A and 10B are partially enlarged views illustrating a state in which a filter is held in the filter unit of FIG. 9;

FIG. 11 is a perspective view illustrating a state before a filter is held by a filter unit of the filter according to Modification 3; and

FIG. 12 is a configuration diagram illustrating the filter unit in which the filter of FIG. 11 is installed.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below in detail with reference to drawings. Identical or corresponding parts in the drawings are given identical reference numerals, and redundant description thereof is simplified or omitted accordingly.

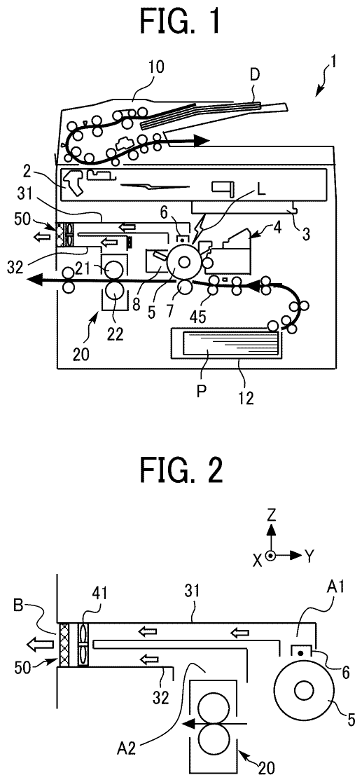

First, an overall configuration/operation of an image forming apparatus 1 will be described with reference to FIG. 1.

In FIG. 1, a copying machine 1 serves as an image forming apparatus, a document reading unit 2 optically reads image information of an original document D, and an exposure unit 3 irradiates a photosensitive drum 5 with exposure light L based on the image information read by the document reading unit 2.

Further, a developing device 4 develops a latent image formed on the photosensitive drum 5 to form a toner image (image), a photosensitive drum 5 serves as an image bearer, a charging device (charging charger) 6 serves as an ozone generation unit that charges the surface of the photosensitive drum 5, a transfer device (transfer roller) 7 transfers the toner image formed on the photosensitive drum 5 to a sheet P, and a cleaning device 8 removes untransferred toner remaining on the photosensitive drum 5.

Further, a document conveying unit 10 conveys the set original document D to the document reading unit 2, a sheet feeder (sheet feeding cassette) 12 stores the sheet P such as paper, a fixing device 20 heats a toner image (unfixed image) on the sheet P and fixes the toner image to the sheet P, a fixing roller 21 is installed in the fixing device 20, a pressure roller 22 is installed in the fixing device 20, exhaust ducts (exhaust paths) such as the first duct 31 and the second duct 32 collect ozone or the like generated in the image forming apparatus 1 by a filter unit 50 and discharge merely air to the outside of the apparatus, a timing roller 45 (registration roller) conveys the sheet P toward the transfer device 7 (transfer nip), and a filter unit 50 is installed in the exhaust ducts (first duct 31 and second duct 32).

Operation of the image forming apparatus during normal image formation will be described with reference to FIG. 1.

First, the original document D is conveyed by conveyance rollers of the document conveying unit 10 from a document loading table in a direction indicated by an arrow in the drawing, and then passes over the document reading unit 2. At this time, the document reading unit 2 optically reads image information of the original document D passing over the document reading unit 2.

The optical image information read by the document reading unit 2 is converted into an electric signal and then transmitted to an exposure unit 3 (writing device). Then, the exposure light L (laser light) based on the image information of the electric signal is emitted from the exposure unit 3 onto the photosensitive drum 5.

On the other hand, the photosensitive drum 5 as the image bearer rotates in a clockwise direction in the drawing, and an image (toner image) corresponding to the image information is formed on the photosensitive drum 5 through a predetermined image forming process (charging step, exposure step, and developing step). Thereafter, the image formed on the photosensitive drum 5 is transferred onto the sheet P conveyed by the timing roller 45 at a position facing the transfer device 7 (transfer nip).

Specifically, the photosensitive drum 5 rotates in the clockwise direction in FIG. 1. First, the surface of the photosensitive drum 5 is uniformly charged at a position facing the charging device 6 (charging step). Thus, a charging potential is formed on the photosensitive drum 5. In the present embodiment, a known corona discharge type charging charger is used as the charging device 6.

Thereafter, the charged surface of the photosensitive drum 5 reaches an irradiation position of the exposure light L. Then, an electrostatic latent image based on the image information read by the document reading unit 2 is formed on the surface of the photosensitive drum 5 (exposure step).

Thereafter, the surface of the photosensitive drum 5 on which the electrostatic latent image is formed reaches a position facing the developing device 4. A toner is supplied from the developing device 4 onto the photosensitive drum 5, and the latent image on the photosensitive drum 5 is developed (developing step).

Thereafter, the surface of the photosensitive drum 5 after the developing step reaches the position facing the transfer device 7 (transfer nip). Then, at the position of the transfer device 7, the toner image formed on the photosensitive drum 5 is transferred onto the sheet P (transfer step). Note that a transfer bias having a polarity different from the polarity of the toner is applied to the transfer device 7 (transfer roller).

Then, the surface of the photosensitive drum 5 after the transfer step reaches a position facing the cleaning device 8. The cleaning device 8 removes and collects the untransferred toner remaining on the photosensitive drum 5 (cleaning step).

Thereafter, the surface of the photosensitive drum 5 passes through a charge-removing unit, and a series of image forming processes on the photosensitive drum 5 is completed.

On the other hand, the sheet P conveyed to the position (transfer nip) of the transfer device 7 operates as follows.

First, the uppermost one sheet P stored in the sheet feeder 12 is fed by a sheet feeding roller toward a conveyance path in which a plurality of conveyance roller pairs is installed. Thereafter, the sheet P reaches a position of the timing roller 45. The sheet P that has reached the position of the timing roller 45 is conveyed toward the transfer device 7 (transfer nip) in accordance with a timing for aligning with the image formed on the photosensitive drum 5.

After the transfer step, the sheet P passes the position of the transfer device 7 and then reaches the fixing device 20 through the conveyance path. The sheet P that has reached the fixing device 20 (the sheet P bearing an unfixed image) is fed in between the fixing roller 21 (in which a heater as a heat source is installed) and the pressure roller 22, and the toner image (image) is fixed by heat received from the fixing roller 21 and pressure received from both the fixing roller 21 and the pressure roller 22. The sheet P on which the toner image is fixed is sent out from between the fixing roller 21 and the pressure roller 22 (fixing nip), and then discharged from the main body of the image forming apparatus 1.

In this way, a series of image formation processes is completed.

Next, in the present embodiment, an exhaust path provided in the image forming apparatus 1 will be described.

Referring to FIGS. 1, 2, and the like, the image forming apparatus 1 according to the present embodiment is provided with an exhaust path such as the exhaust ducts including the first duct 31 and the second duct 32 for collecting ozone or the like generated in the apparatus by the filter unit 50 and discharging the air excluding the ozone or the like to the outside of the apparatus.

The first duct 31 is for exhausting air from the vicinity of the charging device 6 as an ozone generation unit toward the outside of the main body of the image forming apparatus 1. The first duct 31 is provided with a suction port A1 at an upstream end portion in the vicinity of the charging device 6, and merges with the second duct 32 on the downstream side.

The second duct 32 is for exhausting air from the vicinity of the fixing device 20 as a hot air generation unit toward the outside of the main body of the image forming apparatus 1. The second duct 32 is provided with a suction port A2 at an upstream end portion in the vicinity of the fixing device 20, and merges with the first duct 31 on the downstream side.

A suction fan 41 and the filter unit 50 are installed in a path where the first duct 31 and the second duct 32 merge.

The suction fan 41 generates an airflow (an airflow in a direction of a white arrow) from the right side to the left side in FIGS. 1 and 2.

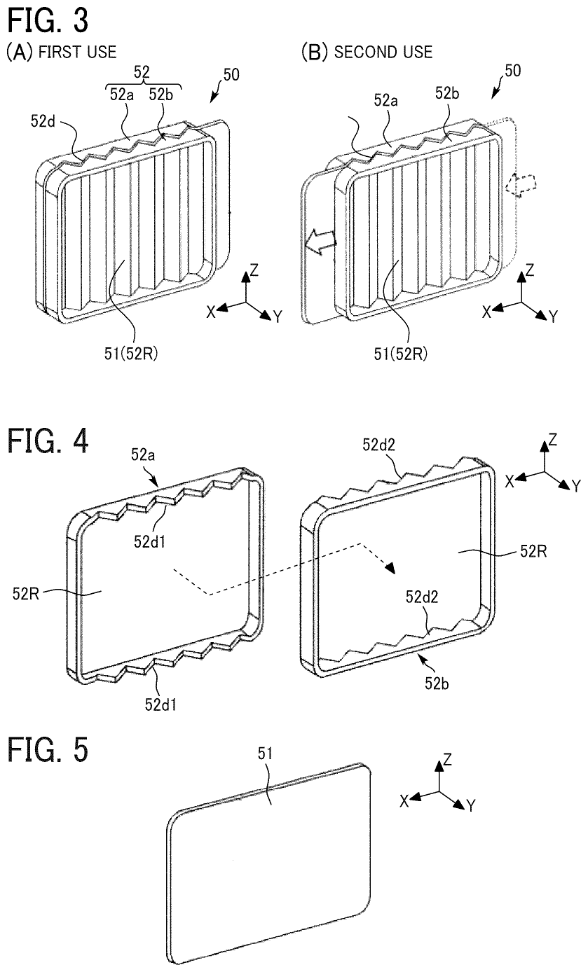

In the filter unit 50, a filter 51 is fitted into an outer frame 52 (see FIGS. 3(A) and 3(B)). The filter 51 (filter unit 50) can collect ozone generated by the charging device 6 as the ozone generation unit, ultrafine particles (UFP) ionized by the ozone, volatile organic compounds generated through a fixing step by the fixing device 20, and the like.

With such a configuration, air flowing through the first duct 31 and the second duct 32 by the suction fan 41 is discharged from a discharge port B to the outside of the apparatus after objects to be collected such as ozone, UFP, and the volatile organic compounds are removed by the filter unit 50.

In the present embodiment, the filter unit 50 is detachably installed on the main body of the image forming apparatus 1 by screw fastening, engagement by snap-fit, or the like so as to close the discharge port B.

Next, in the present embodiment, characteristic configurations and operations of the filter unit 50 installed in the image forming apparatus 1 including the exhaust ducts (the first duct 31 and the second duct 32) is described in detail.

As illustrated in FIGS. 3(A), 3(B), 4, and 5, the filter unit 50 in the present embodiment includes the outer frame 52 in which a vent 52R is formed inside, and the filter 51 held by the outer frame 52 so as to close the vent 52R.

The outer frame 52 is a frame body having an inside of a substantially rectangular parallelepiped shape that is penetrated as the vent 52R. In the outer frame 52 in the present embodiment, conversion portions 52d that deform the filter 51 into a pleated shape (accordion shape) in a transverse direction (a ±X direction orthogonal to a longitudinal direction) at the vent 52R are formed at both end portions (edge portions) in the longitudinal direction (±Z direction) sandwiching the vent 52R.

The filter 51 is formed in a substantially plate shape as illustrated in FIG. 5 in a state before being installed (secured) into the outer frame 52 (state of the filter 51 alone). Then, when the filter 51 is installed (secured) into the outer frame 52, as illustrated in FIGS. 3(A) and 3(B), the filter 51 is deformed in a zigzag manner in the ±X direction into a pleated shape at the portion of the vent 52R inside the outer frame 52.

Specifically, as illustrated in FIG. 4, the outer frame 52 includes two divided outer frames 52a and 52b that are dividable in a ventilation direction (a ±Y direction orthogonal to the transverse direction (±X) and the longitudinal direction (±Z)).

The conversion portions 52d (see FIG. 3(A) and 3(B)) are V-shaped recesses and protrusions 52d1 and 52d2, which are formed continuously in the transverse direction (±X direction) at facing portions of the two divided outer frames 52a and 52b, respectively, and are portions fitted with the filter 51 interposed therebetween.

In other words, of the four edge portions (wall portions) that surround the vent 52R so as to face the counterpart divided outer frame, in each of the two divided outer frames 52a and 52b, the facing surfaces of the two edge portions (wall portions) that face each other in the X direction are planar surfaces, and the two edge portions (wall portions) that face each other in the Z direction are zigzag-shaped uneven surfaces.

More specifically, in the divided outer frame 52a, the V-shaped recesses and protrusions 52d1 (V-shaped wavy recesses and protrusions) continuously connected in the ±X direction are formed at the facing portions (portions facing the other divided outer frame 52b) of two sides extending in the ±X direction among the four sides (four edge portions) forming the vent 52R.

Similarly, in the other divided outer frame 52b as well, the V-shaped recesses and protrusions 52d2 (V-shaped wavy recesses and protrusions) continuously connected in the ±X direction are formed at the facing portions (portions facing the divided outer frame 52a) of two sides extending in the ±X direction among the four sides (four edge portions) forming the vent 52R.

The recesses and protrusions 52d1 of the divided outer frame 52a and the recesses and protrusions 52d2 of the other divided outer frame 52b are out of phase with each other in the ±X direction, and when both of the divided outer frames 52a and 52b are brought together, the recesses and protrusions 52d1 and 52d2 mesh with each other.

The filter 51 is sandwiched between the recesses and protrusions 52d1 and 52d2 (conversion portions 52d), thereby being deformed into a pleated shape so as to follow the shapes of the V-shaped recesses and protrusions 52d1 and 52d2 (conversion portions 52d).

Then, the filter 51 is set such that its length in the longitudinal direction (±Z direction) is equal to or greater than the length of the outer frame 52 in the longitudinal direction (±Z direction), so that the filter 51 is sandwiched between the recesses and protrusions 52d1 and 52d2 (conversion portions 52d) of the outer frame 52 (so that the entire surface of the vent 52R is closed by the filter 51). The recesses and protrusions 52d1 and 52d2 are an example of the conversion portion.

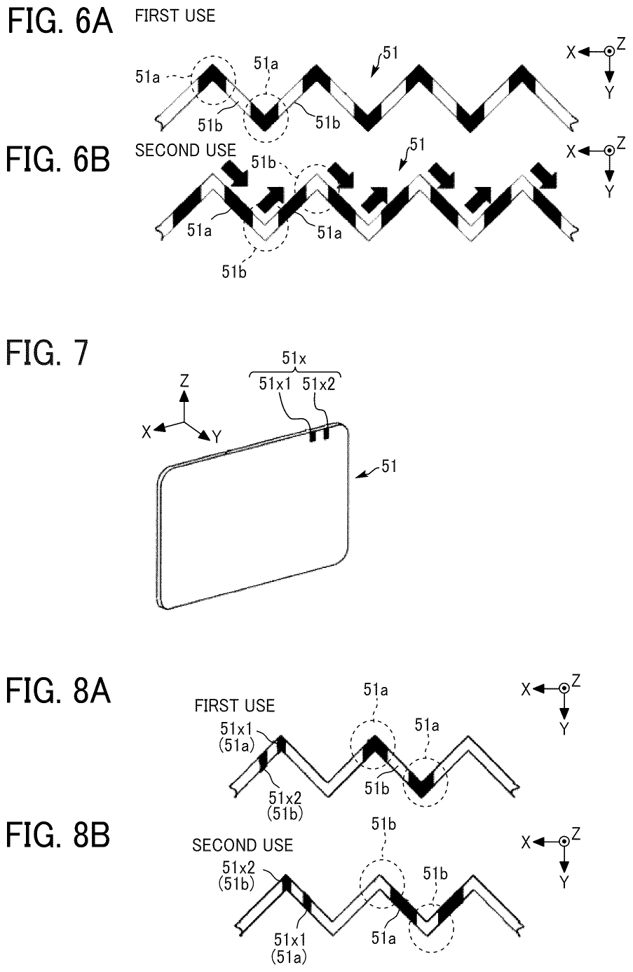

Here, referring to FIGS. 3(A), 3(B), 6A and 6B, the filter unit 50 according to the present embodiment can move the filter 51 in the transverse direction (+X direction) and displace a portion, which is a ridge-valley portion 51a of the pleated filter 51, to a non-ridge-valley portion 51b in the vent 52R.

Specifically, when the filter unit 50 in the present embodiment is first set in the image forming apparatus 1 and the filter 51 is clogged over time and the function as the filter 51 is deteriorated, the existing filter 51 is shifted in the transverse direction and reused without replacing the filter unit with a new filter unit 50 or replacing merely the filter 51 with a new filter. As described above, the filter unit 50 set in the image forming apparatus 1 is used in two different modes in total, that is, a first use, and a second use in which the filter 51 is shifted in the transverse direction relative to the first use.

Referring to FIGS. 3(A) and 6A, when the filter unit 50 is first used in the image forming apparatus 1 (first use), the filter 51 is held by the outer frame 52 such that a part of the filter 51 protrudes from the −X direction end portion of the outer frame 52. Then, the filter 51 is deformed into a pleated shape at the vent 52R of the outer frame 52. That is, as illustrated in FIG. 6A, in the vent 52R, the filter 51 is formed with the ridge-valley portion 51a (a portion that is a ridge or a valley) and the non-ridge-valley portion 51b (a portion that is not a ridge or a valley but is flat).

Thus, since the pleated filter 51 has a larger area of the collection surface (ventilation surface) of the filter 51 than a flat one, the collection efficiency for the objects to be collected is higher.

However, the ridge-valley portion 51a, due to its bent shape, is hardly ventilated and becomes a dead space that hardly contributes to collection of the objects to be collected. In other words, the ridge-valley portion 51a is a portion where clogging hardly occurs even when the non-ridge-valley portion 51b is clogged over time.

For this reason, when the filter 51 is clogged over time in the first use, the filter unit 50 is once removed from the image forming apparatus 1, and as illustrated in FIGS. 3(B) and 6B, the filter 51 is shifted in the +X direction, a portion that is the ridge-valley portion 51a in the first use is defined as a non-ridge-valley portion, and a portion that is the non-ridge-valley portion 51b in the first use is defined as a ridge-valley portion. Therefore, when the filter unit 50 is used in the image forming apparatus 1 for the second time (at the time of the second use), the filter 51 is held by the outer frame 52 such that a part of the filter 51 protrudes from the +X direction end portion of the outer frame 52.

The work of shifting the filter 51 in this manner is work of once dividing the divided outer frames 52a and 52b in the first use, aligning the filter 51 so that the ridge-valley portion and the non-ridge-valley portion of the filter 51 are interchanged, and then fitting the divided outer frames 52a and 52b again.

In addition, the clogging of the filter 51 in the first use may be determined through visual confirmation by a service engineer, or may be indirectly determined from the accumulated operating time of the image forming apparatus 1.

As described above, in the filter unit 50 according to the present embodiment, in the filter 51 deformed into a pleated shape, the ridge-valley portion 51a that is a dead space and is not clogged in the first use is used as the non-ridge-valley portion in the second use, and thus, it is possible to increase the service life of the filter 51 having a pleated shape with enhanced collection efficiency to about twice.

As described above, the filter unit 50 according to the present embodiment shifts the position of the filter 51 in the transverse direction between the first use and the second use.

Therefore, the filter 51 is set such that its length in the transverse direction (±X direction) is longer than the length in the transverse direction (±X direction) of the outer frame 52.

In particular, the length of the filter 51 in the ±X direction is set to be longer than the length of the outer frame 52 in the ±X direction by at least the pitch of the ridge-valley portions 51a (or the non-ridge-valley portions 51b) which are adjacent.

### Modification 1

As illustrated in FIGS. 7, 8A and 8B, in the filter unit 50 according to Modification 1, the filter 51 is provided with a mark 51x indicating a movement position for displacing a portion that is the ridge-valley portion 51a in the first use to the non-ridge-valley portion in the second use.

Specifically, the mark 51x is a pair: a first mark 51x1 matching the position of the ridge-valley portion 51a and a second mark 51x2 matching the position of the non-ridge-valley portion 51b in the first use. Therefore, the first mark 51x1 matches the position of the non-ridge-valley portion in the second use, and the second mark 51x2 matches the position of the ridge-valley portion in the second use.

Specifically, in the assembly work of the filter unit 50 in the first use, as illustrated in FIG. 8A, the filter 51 is sandwiched between the two divided outer frames 52 in a state where the position of the filter 51 in the ±X direction is aligned such that the first mark 51x1 is positioned at the ridge-valley portion 51a. At this time, even when the filter 51 is assembled to the outer frame 52, the mark 51x (the first mark 51x1 and the second mark 51x2) can be visually recognized from the gap of the conversion portions 52d as illustrated in FIG. 8A, and thus, the alignment of the filter 51 in the ±X direction can be easily performed.

As illustrated in FIG. 8B, in the assembly work of the filter unit 50 in the second use, the filter 51 is sandwiched between the two divided outer frames 52 in a state where the position of the filter 51 in the ±X direction is aligned such that the second mark 51x2 is positioned at the ridge-valley portion. At this time, even when the filter 51 is assembled to the outer frame 52, the mark 51x (the first mark 51x1 and the second mark 51x2) can be visually recognized from the gap of the conversion portions 52d as illustrated in FIG. 8B, and thus, the alignment of the filter 51 in the ±X direction can be easily performed.

Even in the case of the configuration as in Modification 1, the collection efficiency and the service life of the filter 51 can be enhanced. In particular, in Modification 1, the mark 51x is formed on the filter 51, and thus, it is possible to easily perform the work of interchanging the ridge-valley portion and the non-ridge-valley portion between the first use and the second use.

In Modification 1, for example, the first mark 51x1 and the second mark 51x2 can be color-coded in order to easily distinguish the first mark 51x1 from the second mark 51x.

### Modification 2

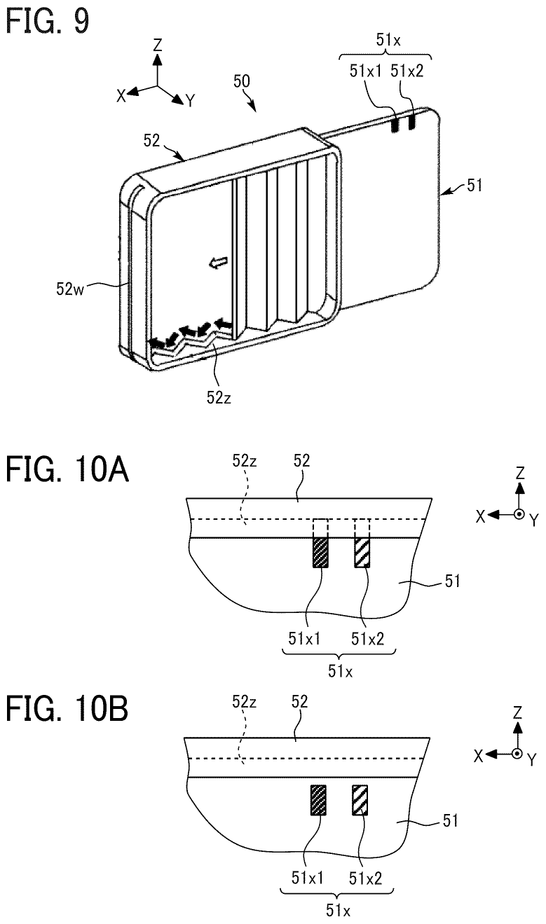

As illustrated in FIG. 9, in the filter unit 50 according to Modification 2, the outer frame 52 is configured so as not to be divided (integrally formed as one component), unlike those illustrated in FIGS. 3(A), 3(B), and 4.

In the outer frame 52, slits 52w that enable movement of the filter 51 in the transverse direction (±X direction) are formed respectively at both end portions in the transverse direction (±X direction) sandwiching the vent 52R. The length of the slit 52w in the longitudinal direction (±Z direction) is set to be equal to or greater than the length of the filter 51 in the longitudinal direction (±Z direction).

Further, the outer frame 52 has V-shaped groove portions 52z that are continuously formed in the transverse direction (±X direction) on the inside where the vent 52R is formed, and are respectively formed at both end portions in the transverse direction. The V-shaped groove portions 52z movably hold the filter 51 in the transverse direction (±X direction) and function as the conversion portions that deform the filter 51 into a pleated shape at the vent 52R. The V-shaped groove portions 52z is also referred to as a V-shaped wavy portion and is an example of the conversion portion.

Note that, in a case where the outer frame 52 is integrally formed as one component so as not to be divided as described above, the filter 51 needs to be reliably engaged with the groove portions 52z formed inside the outer frame 52. Therefore, the filter 51 is set such that its length in the longitudinal direction (±Z direction) is longer than the length in the longitudinal direction (±Z direction) of the vent 52R and shorter than the length in the longitudinal direction (±Z direction) of the outer frame 52 (the width in the ±Z direction of the two groove portions 52z).

In a case where the filter unit 50 is configured as described above, as illustrated in FIG. 9, the filter 51 is inserted from the slits 52w on one end side (−X direction side), and is deformed into a pleated shape while being pulled in the +X direction (white arrow direction) by the groove portions 52z (conversion portions) serving as a guide. Finally, the other end side of the filter 51 deformed into a pleated shape in the vent 52R is slightly pulled out from the slits 52w on the other end side (+X direction side). At this time, positioning in the ±X direction is performed such that the first mark 51x1 formed on the filter 51 matches the ridge-valley portion 51a and the second mark 51x2 matches the non-ridge-valley portion 51b, and, in that state, the first use in the image forming apparatus 1 is performed.

Then, in the second use, in the filter unit 50 taken out from the image forming apparatus 1, the filter 51 is pulled in the +X direction from the slits 52w on the other end side (+X direction side), positioning in the ±X direction is performed such that the second mark 51x2 matches the ridge-valley portion and the first mark 51x1 matches the non-ridge-valley portion, and, in that state, the filter unit 50 is set in the image forming apparatus 1 and the second use is performed.

Note that, in Modification 2, the filter 51 in the vent 52R cannot be visually recognized from a side surface of the outer frame 52 (which is a side surface in the Z direction on which the groove portions 52z are formed), and thus, as illustrated in FIG. 10A, the mark 51x (the first mark 51x1 and the second mark 51x2) is formed at a position that can be visually recognized from the vent 52R.

Here, since it is possible that the portion where the mark 51x is formed does not function as the filter 51 or the function thereof is deteriorated, it is preferable that the range of the portion be formed small enough not to hinder visual recognition.

The mark 51x (the first mark 51x1 and the second mark 51x2) does not need to be in contact with the outer frame 52 as illustrated in FIG. 10A, and can be formed at a position away from the outer frame 52 as illustrated in FIG. 10B.

Even in the case of the configuration as in Modification 2, the collection efficiency and the service life of the filter 51 can be enhanced. In particular, in Modification 2, the outer frame 52 is formed as one component, and thus, the number of components of the filter unit 50 is reduced, and the movement work of the filter 51 in the second use can be easily performed.

### Modification 3

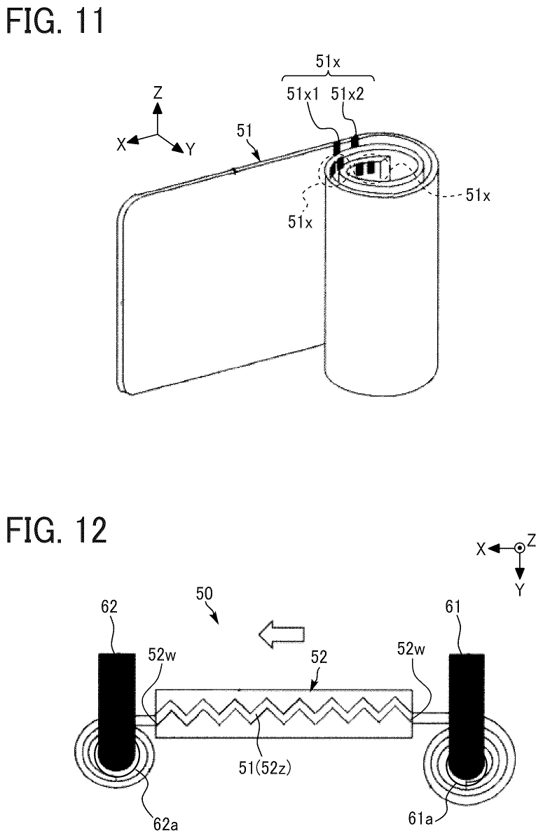

As illustrated in FIGS. 11 and 12, in the filter unit 50 according to Modification 3, the filter 51 is wound in a roll shape, and its length in the transverse direction (±X direction) is sufficiently longer than the length of the outer frame 52 in the transverse direction (±X direction). As illustrated in FIG. 11, a plurality of marks 51x (the first marks 51x1 and the second marks 51x2) is formed on the roll-shaped filter 51 at intervals (intervals equal to or longer than the length of the outer frame 52 in the X direction) in the transverse direction. Note that, in Modification 3, the outer frame 52 has been described above with reference to FIG. 9, and is integrally formed as one component.

Then, as illustrated in FIG. 12, the filter unit 50 is provided with a filter supplier 61 that winds the filter 51 in a roll shape on the outer side of one end side of the outer frame 52 in the transverse direction (the outer side on the −X direction side), and a filter collector 62 that winds the filter 51 in a roll shape on the outer side of the other end side of the outer frame 52 in the transverse direction (the outer side on the +X direction side). The filter 51 sufficiently wound around a core shaft 61a in a roll shape in the filter supplier 61 in the first use (at the initial stage) has the other end side coupled to a core shaft 62a of the filter collector 62 via the outer frame 52. In the second use, the core shaft 62a of the filter collector 62 is rotated in the counterclockwise direction in FIG. 12 through winding by a drive motor (or manual winding), so that the portion of the filter 51 deformed into a pleated shape in the outer frame 52 moves in the +X direction while the core shaft 61a of the filter supplier 61 is driven and rotated in the counterclockwise direction in FIG. 12, and the portion that once was the ridge-valley portion 51a and the non-ridge-valley portion are interchanged. Furthermore, in a third use, a portion used twice is wound around the filter collector 62, and a new filter portion supplied from the filter supplier 61 is inserted into the outer frame 52 via the slits 52w. At this time, the filter 51 is aligned in the ±X direction such that the first mark 51x1 of the second pair of the mark 51x matches the ridge-valley portion 51a. In a fourth use, the filter 51 is aligned in the ±X direction such that the second mark 51x2 of the second pair of the mark 51x matches the ridge-valley portion. Thereafter, a winding step in which two uses are defined as one set is repeatedly performed in accordance with the winding amount (length) of the filter 51.

Note that the filter unit 50 provided with the filter supplier 61 and the filter collector 62 as described above is installed in the image forming apparatus 1 as it is. The winding step of the filter 51 described above can be executed without detaching the filter unit 50 from the image forming apparatus 1.

Even in the case of the configuration as in Modification 3, the collection efficiency and the service life of the filter 51 can be enhanced. In particular, in Modification 3, the filter 51 is wound in a roll shape, and a plurality of sets of winding steps of the filter 51, with two uses being defined as one set, can be performed, and thus, the service life of the filter 51 can be set longer.

As described above, the filter unit 50 in the present embodiment is provided with the outer frame 52 in which the vent 52R is formed inside, and the filter 51 held by the outer frame 52 so as to close the vent 52R. Further, the outer frame 52 has the conversion portions 52d formed at both end portions in the longitudinal direction (±Z direction) sandwiching the vent 52R, the conversion portions 52d deforming the filter 51 in the vent 52R into a pleated shape in the transverse direction (±X direction) orthogonal to the longitudinal direction. The filter unit 50 can move the filter 51 in the transverse direction (+X direction) to displace the portion, which is the ridge-valley portion 51a of the pleated filter 51, to the non-ridge-valley portion in the vent 52R.

As a result, the collection efficiency of the filter 51 is high and the service life of the filter 51 is long.

Note that although the present embodiment is applied to the filter unit 50 installed in the monochrome image forming apparatus 1, the present embodiment can also be applied to a filter unit installed in a color image forming apparatus. Furthermore, the present embodiment can also be applied to a filter unit installed in a device different from an image forming apparatus or a non-device which is not a device (for example, a filter unit installed in a house).

Although the present embodiment is applied to the filter unit 50 installed in the exhaust path where the two ducts (the first duct 31 and the second duct 32) merge, the filter unit is not limited to this, and the present embodiment can also be applied to a filter unit installed in an exhaust path of another aspect, a filter unit installed in an intake path, or the like.

Although the filter unit 50 (filter 51) collects ozone, UFP, and the volatile organic compounds as the objects to be collected, the filter unit 50 (filter 51) can collect one or two ozone, UFP, and the volatile organic compounds as the objects to be collected, or can collect entirely different objects as the objects to be collected.

Even in such cases, an effect similar to that of the present embodiment can be obtained.

A filter unit includes: a filter (51) having a plate shape elongated in a longitudinal direction (X); a pair of outer frames (52a, 52b) sandwiching the filter (51) between the pair of outer frames (52a, 52b), wherein the pair of outer frames (52a, 52b) has an opening (52R) covered by the filter (51) sandwiched by the pair of outer frames (52a, 52b); and the pair of outer frames (52a, 52b) includes: a pair of conversion portions (52d1, 52d2) each having a pleated face along a longitudinal direction (X) of the pair of outer frames (52a, 52b), the pair of conversion portions (52d1, 52d2) to deform, into a pleated shape, both ends of the filter (51) in a transverse direction (Z) orthogonal to the longitudinal direction (X); and a pair of flat portions each having a flat face along the transverse direction, and the pair of outer frames (52a, 52b) is detachably engageable with each other to change the pleated shape of the filter by the pair of conversion portions (52d1, 52d2).

The pair of outer frames (52a, 52b) is detachably engageable with each other to change a position of the filter relative to the pair of outer frames (52a, 52b) in the longitudinal direction, to change the pleated shape of the filter by the pair of conversion portions (52d1, 52d2).

The filter sandwiched by the pleated face of the pair of conversion portions (52d1, 52d2) has: ridge-valley portions; and non-ridge valley portions, each disposed between two of the ridge-valley portions, the ridge-valley portions and the non-ridge valley portions are arranged alternately in the longitudinal direction, and the filter has a mark indicating a deforming position where: the ridge-valley portions is deformed to the non-ridge valley portions; and the non-ridge valley portions is deformed to the ridge-valley portions.

The pair of outer frames are divided in a ventilating direction orthogonal to the longitudinal direction and the transverse direction, and the pleated face of each of the pair of conversion portions have V-shaped recesses and protrusions formed continuously in the longitudinal direction, and each of V-shaped recesses and protrusions are engaged with each other, with the filter interposed between the V-shaped recesses and protrusions of the pair of conversion portions of the pair of outer frames.

The pair of outer frames have a first length in the longitudinal direction, and the filter has a second length equal to or longer than the first length in the longitudinal direction.

A filter unit includes: a filter (51) having a plate shape elongated in a longitudinal direction (X); an outer frame (52a, 52b) having a slit through which the filter (51) is movable in the longitudinal direction, wherein the outer frame (52a, 52b) has an opening (52R) covered by the filter (51) in the slit; and the slit has: a conversion portion (52z): disposed at one end of the outer frame (52a, 52b) in a transverse direction orthogonal to the longitudinal direction (X); having a pleated face along a longitudinal direction (X) of the outer frame (52a, 52b); to deform the filter into a pleated shape; and a pair of flat portions at each end of the outer frame in the longitudinal direction, each having a flat face along the transverse direction, and the filter (51) is movable in the longitudinal direction to change the pleated shape of the filter by the conversion portion (52z).

The filter moved through the slit having the plated shape has: ridge-valley portions; and non-ridge valley portions, each disposed between two of the ridge-valley portions, the ridge-valley portions and the non-ridge valley portions are arranged alternately in the longitudinal direction, and the filter has a mark indicating a deforming position where: ridge-valley portions is deformed to the non-ridge valley portions; and the non-ridge valley portions is deformed to the ridge-valley portions.

The opening of the outer frame has a first length in the transverse direction, and the opening of the outer frame has a second length in the transverse direction, and the filter has a third length longer than the first length and shorter than the second length in the transverse direction.

The outer frame has a first length in the longitudinal direction, and the filter has a second length equal to or longer than the first length in the longitudinal direction.

The filter unit further includes: a filter supplier to supply the filter to the outer frame in the longitudinal direction; and a filter collector to collect the filter from the outer frame in the longitudinal direction, wherein the filter supplier has a first shaft around which the filter is wound in a roll shape, the filter supplier is at one side of the outer frame in the longitudinal direction; and the filter collector has a second shaft around which the filter is wound in a roll shape, the filter collector is at another side of the outer frame in the longitudinal direction.

An image forming apparatus includes: a body; an exhaust duct inside the body; and the filter unit according to claim 1 or 6 at one end of the exhaust duct.

According to the present embodiment, it is possible to provide a filter unit and an image forming apparatus in which a filter has high collection efficiency and a long service life.

The present disclosure is not limited to the present embodiment and it is apparent that the present disclosure can be modified as appropriate without departing from the technical idea of the present disclosure in addition to what is suggested in the present embodiment. Furthermore, the number, position, shape, and so forth of the constituent members are not limited to the present embodiment, and may be the number, position, shape, and so forth that are suitable for implementing the present embodiment.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A filter unit comprising:
a filter having a plate shape elongated in a longitudinal direction;
a pair of outer frames sandwiching the filter between the pair of outer frames,
wherein the pair of outer frames has an opening covered by the filter sandwiched by the pair of outer frames; and
the pair of outer frames includes:
a pair of conversion portions each having a pleated face along a longitudinal direction of the pair of outer frames,
the pair of conversion portions to deform, into a pleated shape, both ends of the filter in a transverse direction orthogonal to the longitudinal direction; and
a pair of flat portions each having a flat face along the transverse direction, and
the pair of outer frames is detachably engageable with each other to change the pleated shape of the filter by the pair of conversion portions.

2. The filter unit according to claim 1,
wherein the pair of outer frames is detachably engageable with each other to change a position of the filter relative to the pair of outer frames in the longitudinal direction,
to change the pleated shape of the filter by the pair of conversion portions.

3. The filter unit according to claim 1,
wherein the filter sandwiched by the pleated face of the pair of conversion portions has:
ridge-valley portions; and
non-ridge valley portions, each disposed between two of the ridge-valley portions,
the ridge-valley portions and the non-ridge valley portions are arranged alternately in the longitudinal direction, and
the filter has a mark indicating a deforming position where:
the ridge-valley portions is deformed to the non-ridge valley portions; and
the non-ridge valley portions is deformed to the ridge-valley portions.

4. The filter unit according to claim 1,
wherein the pair of outer frames are divided in a ventilating direction orthogonal to the longitudinal direction and the transverse direction, and
the pleated face of each of the pair of conversion portions have V-shaped recesses and protrusions formed continuously in the longitudinal direction, and
each of V-shaped recesses and protrusions are engaged with each other, with the filter interposed between the V-shaped recesses and protrusions of the pair of conversion portions of the pair of outer frames.

5. The filter unit according to claim 4,
wherein the pair of outer frames have a first length in the longitudinal direction, and
the filter has a second length equal to or longer than the first length in the longitudinal direction.

6. A filter unit comprising:
a filter having a plate shape elongated in a longitudinal direction;
an outer frame having a slit through which the filter is movable in the longitudinal direction,
wherein the outer frame has an opening covered by the filter in the slit; and
the slit has:
a conversion portion:
disposed at one end of the outer frame in a transverse direction orthogonal to the longitudinal direction; and
having a pleated face along a longitudinal direction of the outer frame;
to deform the filter into a pleated shape; and
a pair of flat portions at each end of the outer frame in the longitudinal direction, each having a flat face along the transverse direction, and
the filter is movable in the longitudinal direction to change the pleated shape of the filter by the conversion portion.

7. The filter unit according to claim 6,
wherein the filter moved through the slit having the plated shape has:
ridge-valley portions; and
non-ridge valley portions, each disposed between two of the ridge-valley portions,
the ridge-valley portions and the non-ridge valley portions are arranged alternately in the longitudinal direction, and
the filter has a mark indicating a deforming position where:
the ridge-valley portions is deformed to the non-ridge valley portions; and
the non-ridge valley portions is deformed to the ridge-valley portions.

8. The filter unit according to claim 6,
wherein the opening of the outer frame has a first length in the transverse direction, and
the opening of the outer frame has a second length in the transverse direction, and
the filter has a third length longer than the first length and shorter than the second length in the transverse direction.

9. The filter unit according to claim 6,
wherein the outer frame has a first length in the longitudinal direction, and
the filter has a second length equal to or longer than the first length in the longitudinal direction.

10. The filter unit according to claim 9, further comprising:
a filter supplier to supply the filter to the outer frame in the longitudinal direction;
and a filter collector to collect the filter from the outer frame in the longitudinal direction,
wherein the filter supplier has a first shaft around which the filter is wound in a roll shape,
the filter supplier is at one side of the outer frame in the longitudinal direction; and
the filter collector has a second shaft around which the filter is wound in a roll shape,
the filter collector is at another side of the outer frame in the longitudinal direction.

11. An image forming apparatus comprising:
a body;
an exhaust duct inside the body; and
the filter unit according to claim 1 at one end of the exhaust duct.

12. An image forming apparatus comprising:
a body;
an exhaust duct inside the body; and
the filter unit according to claim 6 at one end of the exhaust duct.
